(19) United States
(12) Patent Application Publication
(10) Pub. No.: US 2008/0289296 A1
(43) Pub. Date: Nov. 27, 2008

(54) Safety bar systems and methods

(76) Inventor: Sidney L. Weber, Jamaica, NY (US)

Correspondence Address: BRANDON N. SKLAR. ESQ. (PATENT PROSECUTION);KAYE SCHOLER, LLP, 425 PARK AVENUE, NEW YORK, NY, 10022-3598, US

(21) Appl. No.: 12/152,351

(22) Filed: May 14, 2008

Related U.S. Application Data
(60) Provisional application No. 60/930,148, filed on May 14, 2007.
(60) Provisional application No. 60/999,574, filed on Oct. 19, 2007.

(51) Int. Cl. A47K 17/02; E04B 1/35; B25G 1/10

(52) U.S. Cl. 52/835; 52/741.3; 16/421

(57) ABSTRACT

Safety bar systems are disclosed comprising a first bar and a second bar selectively lockable to the first bar at a desired height and angle. The second bar may be selectively locked into one of a plurality of positions with respect to the bar or into one of a continuous plurality of positions with respect to the bar, based on the coupling mechanism coupling the second bar to the first bar. Several coupling mechanisms are disclosed. The safety bar system may be connected to a wall adjacent to a bathtub to facilitate a user entering and exiting the bathtub. The safety bar system may be used in other locations, as well. Methods are also disclosed.

The present application claims priority from U.S. Provisional Patent Application No. 60/930,148, which was filed on May 14, 2007 and is incorporated by reference herein in its entirety, and from U.S. Provisional Patent Application No. 60/999,574, which was filed on Oct. 19, 2007 and is incorporated by reference herein in its entirety.

### FIELD OF THE INVENTION

This invention relates generally to systems and methods to provide a secure grip to a person in a potentially risky location. In particular, the invention relates to systems and methods to provide a secure grip to a person in a bathroom or bathtub.

### BACKGROUND OF THE INVENTION

Individuals who have difficulty moving and/or balancing due to a disability, age, or other reasons often find ordinary daily activities, such as using a bathtub or toilet, to be challenging or even dangerous. For example, stepping into or out of a bathtub can be difficult and pose a risk of injury for a person with physical limitations. Serious injury can occur when a person attempts to step into a bathtub but loses his or her balance and falls.

A number of support systems have been developed to enable such individuals to accomplish their daily activities without assistance. For example, bathtubs with doors built into the side of the tub allow a person to enter the bathtub without having to step up and over the side of the tub, thereby reducing the risk of injury. Such bathtubs are available from The Walk In Bathtub Company, located in Farmingdale, N.Y., for example.

### SUMMARY OF THE INVENTION

In accordance with an embodiment of the invention, a safety bar system is disclosed comprising a first bar having a length and defining a plurality of first holes along the length. The is configured to be coupled to a wall. A first tubular member is provided around the first bar. The first tubular member is movable with respect to the bar and is selectively lockable to one of the plurality of holes. A second tubular member is provided, rotatable around the first member. The second tubular member is selectively lockable to the first member in a selected one of a plurality of positions around the first tubular member. A second bar is coupled to the second tubular member such that selective locking of the first tubular member to one of the plurality of holes and selective locking of the second tubular member to the first member defines a position of the second bar with respect to the first bar.

The first tubular member may define a second hole therethrough, which is selectively alignable with a selected one of the plurality of first holes, and the system may further comprise an elongated member insertable into an aligned first and second hole, to selectively lock the first tubular member to the selected first hole. A resilient member, such as a spring, may be coupled to the elongated member, and the elongated member may have a first position within an aligned first and second hole and a second position outside of each of the plurality of first holes, to allow for movement of the first tubular member with respect to the first bar. The resilient member provides a force pushing the elongated member into the first position and resists movement of the elongated member into the second position. The elongated member may be removable from the hole by manually retracting the member from the first hole, compressing the spring.

The first tubular member may define a circumferential section at least partially around the bar and a plurality of third holes circumferentially distributed around the circumferential section, radially through the circumferential section. The second tubular member may then define a fourth hole alignable with a selected one of the third holes. A second elongated member may be provided that is insertable into an aligned third and fourth hole, to lock the second tubular member and the second bar into a selected angular position. A second resilient member, such as a second spring, may be coupled to the second elongated member. The second elongated member may have a first position within an aligned third and fourth holes, and a second position outside of each of the plurality of third holes, to allow for movement of the second tubular member around the first tubular member to align the fourth hole with another third hole. The resilient member may provide a force pushing the second elongated member into the first position and the resilient member may resist movement of the second elongated member into the second position. The second elongated member may also be removable from the third hole by manually retracting the second member from the third hole, compressing the spring.

The second elongated member may be movably coupled to the second bar, such as by being coupled to a third member movably coupled to the second bar and movable with respect thereto. Movement of the third member with respect to the second bar causes movement of the second elongated member between the first and second positions. The third member may comprise a third tubular member surrounding the second bar.

The first tubular member may define a circumferential section at least partially around the bar and a plurality of second holes circumferentially distributed around the circumferential section, radially through the circumferential section. The second tubular member may define a third hole alignable with a selected one of the second holes and a first elongated member may be provided that is insertable into aligned second and third holes, to lock the second tubular member and the second bar into a selected angular position. A resilient member, such as a spring, may be coupled to the first elongated member.

The second tubular member and the second bar may be selectively lockable in a continuous plurality of positions within a range of locations around the bar. The second tubular member may be compressible around a portion of the first tubular member, to selectively lock the second tubular member to the first tubular member. The second tubular member may comprise a C-clamp, for example.

The first tubular member may define a ledge perpendicular thereto. The ledge may have a plurality of circumferential holes extending at least partially around the first tubular member, parallel to the first bar. The second tubular member may comprise an elongated member extending therefrom, toward the first tubular member and parallel to the first bar. The elongated member may be receivable in a selected one of the plurality of circumferential holes. In this example, the angular position of the second bar is varied by lifting the second tubular member to remove the elongated member out of one circumferential hole, rotating the second tubular member around the bar, and lowering the second tubular member to move the elongated member into another circumferential hole.

The first bar may be coupled to a wall in a vertical position. The wall may be adjacent to a bathtub and the second bar may be extendible across the bathtub.

In accordance with another embodiment, a method of using a safety bar is disclosed, comprising moving a first member vertically along a bar to a selected height, to set the height of a horizontal bar, locking the first member to the bar at the selected height, rotating a second member separate from the first member around the bar to a selected position, the second member being coupled to a horizontal bar, and locking the second member in the selected position. The method may further comprise grasping the horizontal bar and entering a bathtub. The method may further comprise grasping the horizontal bar and exiting the bathtub.

In accordance with another embodiment, a safety bar system is disclosed comprising a first bar, a tubular member around the first bar, and a second bar coupled to the tubular member. The tubular member is movable along a length of the first bar and around the first bar to position the tubular member and the second bar into one of a continuous plurality of positions with respect to the bar. The tubular member is selectively compressible to lock the tubular member into the selected one of the continuous plurality of positions with respect to the vertical bar. The tubular member may comprises a C clamp, for example.

In accordance with another embodiment, a safety bar system is disclosed comprising a first bar having a length and defining a plurality of first holes along the length. The bar is configured to be coupled to a wall. A tubular member is provided around the first bar. The tubular member is movable with respect to the first bar and selectively lockable to one of the plurality of holes. A second bar is coupled to the tubular member, such that selective locking of the tubular member to one of the plurality of holes defines a position of the second bar with respect to the first bar. The vertical bar may define a plurality of second holes transverse to the first holes and the first bar may be selectively lockable to one of the second holes. The first holes may be in a vertical line and the second holes may be in a horizontal line intersecting the first, vertical line.

### BRIEF DESCRIPTION OF THE DRAWINGS

The accompanying drawings, in which like reference numerals represent like parts, are incorporated in and constitute a part of the specification. The drawings illustrate presently preferred embodiments of the invention and, together with the general description given above and the detailed description given below, serve to explain the principles of the invention.

FIG. 1A is a front view of an example of a safety bar system, in accordance with a first embodiment of the invention;

FIG. 1B is a perspective view of the safety bar system of FIG. 1A;

FIG. 2 is a disassembled view of the safety bar system of FIG. 1A;

FIGS. 3A-3B are cross-sectional views of open ends of a vertical bar, showing the placement of first and second plugs between the vertical bar and top and bottom elbows, in the safety bar system of FIG. 1A;

FIGS. 4A-4C show an exemplary structure of a vertical ring element, in the safety bar system of FIG. 1A;

FIGS. 5A-5B show an exemplary structure of a spring-loaded pin, in the safety bar system of FIG. 1A;

FIGS. 6A-6B are schematic representations of two positions of a pin portion of a spring-loaded pin, in the example of FIGS. 4A-5B;

FIGS. 7A-7C show an exemplary structure of a tube, in the safety bar system of FIG. 1A;

FIG. 8 shows an exemplary structure of a collar, a tube and a safety bar, with internal components shown in phantom, in accordance with the example of FIG. 1A;

FIGS. 9A-9B show an example of a sleeve, that may be used in the safety bar system of FIG. 1A.

FIG. 10 is another example of a safety bar system, in accordance with the first embodiment of the invention;

FIG. 11 is an example of a safety bar system, in accordance with a second embodiment of the invention;

FIG. 12 is a top view of an example of a locking mechanism, in accordance with the embodiment of FIG. 11; and

FIG. 13A-13B are side and front views, respectively, of a safety bar system, in accordance with a third embodiment of the invention.

### DETAILED DESCRIPTION OF THE PREFERRED EMBODIMENTS

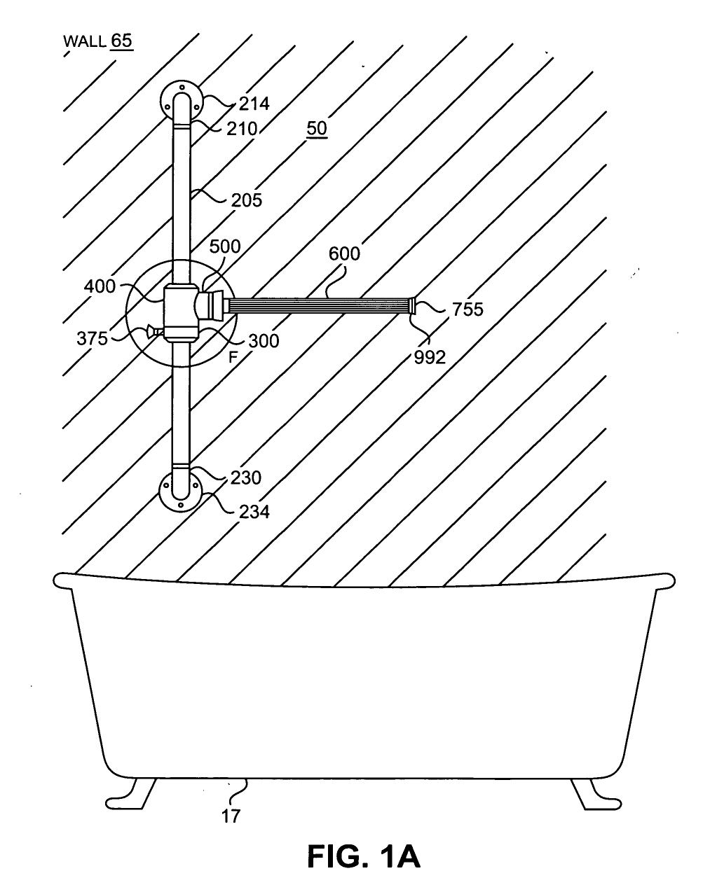

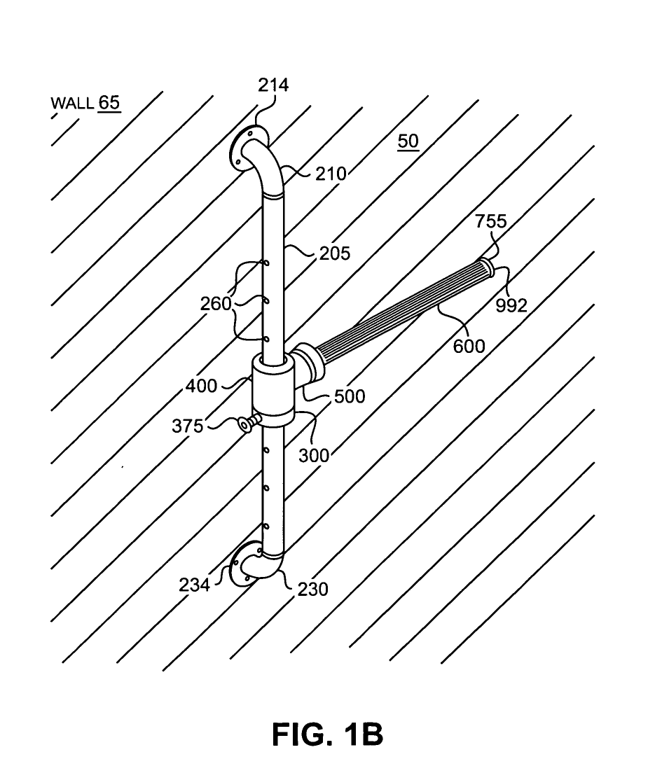

FIG. 1A is a front view of an example of a safety bar system 50, in accordance with an embodiment of the invention, positioned with respect to a bathtub. FIG. 1B is a perspective view of the safety bar system 50 of FIG. 1A. The safety bar system 50 comprises a safety bar 600 coupled to a vertical bar 205. The vertical bar 205 is secured to a wall 65 adjacent to a bathtub 17, for example. The safety bar 600 may be adjusted to, and secured in, a selected vertical and horizontal position suitable for the user by a coupling mechanism and then gripped by the user while the user is entering, exiting, or moving within the bathtub. In this embodiment, the coupling mechanism comprises a vertical ring element 300, which enables adjustment of the vertical height of the safety bar 600 along the vertical bar 205, and rotation of a second tubular member around the vertical bar, here tube 400, to adjust the angle of the safety bar 600 with respect to the wall 65. A spring-loaded pin 375 secured within a hole 348 in the vertical ring element 300 locks the vertical ring element 300 into a selected vertical position on the vertical bar 205 and a pin 521 coupled to the collar 500 locks the collar 500 and the safety bar 600 into a selected angular position, as discussed in more detail, below.

The components of the safety bar system 50 may comprise any suitable material, such as a metal or metal alloy, plastic, wood, one or more composite materials, etc., or a combination of such materials.

### Vertical Bar Component

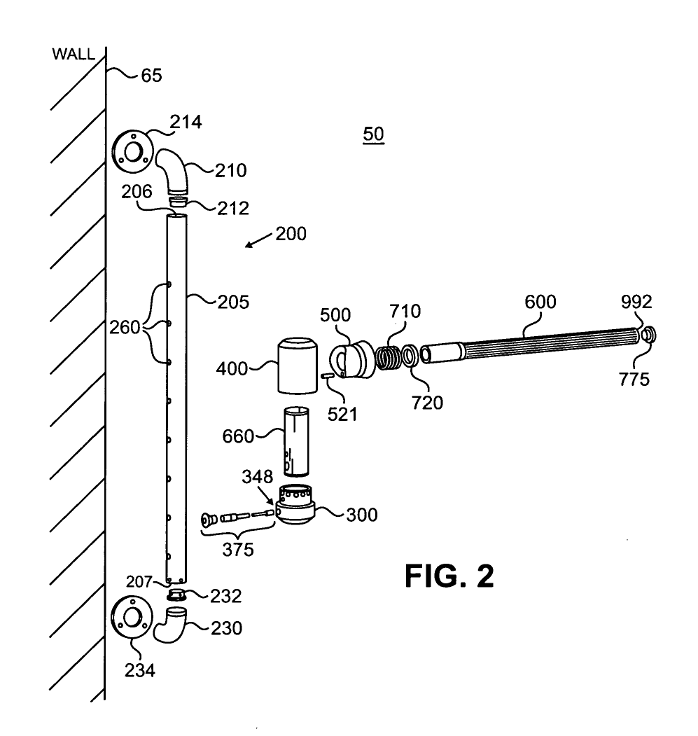

FIG. 2 is a disassembled view of the safety bar system 50 of FIGS. 1A-1B, in which the vertical ring element 300 and the tube 400 are separated from the vertical bar 205.

The vertical bar component 200 comprises the vertical bar 205, and top and bottom elbows 210 and 230 to couple the vertical bar 205 to the wall 65. The vertical bar 205 comprises a plurality of holes 260 situated at selected vertical intervals along the vertical bar 205, to which the vertical ring element 300 may be secured. Each of the holes 260 defines a corresponding vertical position that may be selected for the vertical ring element 300 and for the safety bar 600. The holes 260 may be spaced at equal or at non-equal intervals. The holes 260 may be situated along a straight line, although that is not required.

First and second plugs 212, 232 are received within open top and bottom ends 206, 207 of the vertical bar 205 and in open ends of the top and bottom elbows 210, 230. The top elbow 210 and the bottom elbow 230 are fixed respectively to the wall 65 by wall flanges 214, 234. The top elbow 210 and the bottom elbow 230 are welded to the respective wall flanges 214, 234, by “tigwelding,” which is a tungsten inert gas weld, as is known in the art, for example. The flanges 214, 234 may be fixed to the wall 65 by screws or bolts, for example.

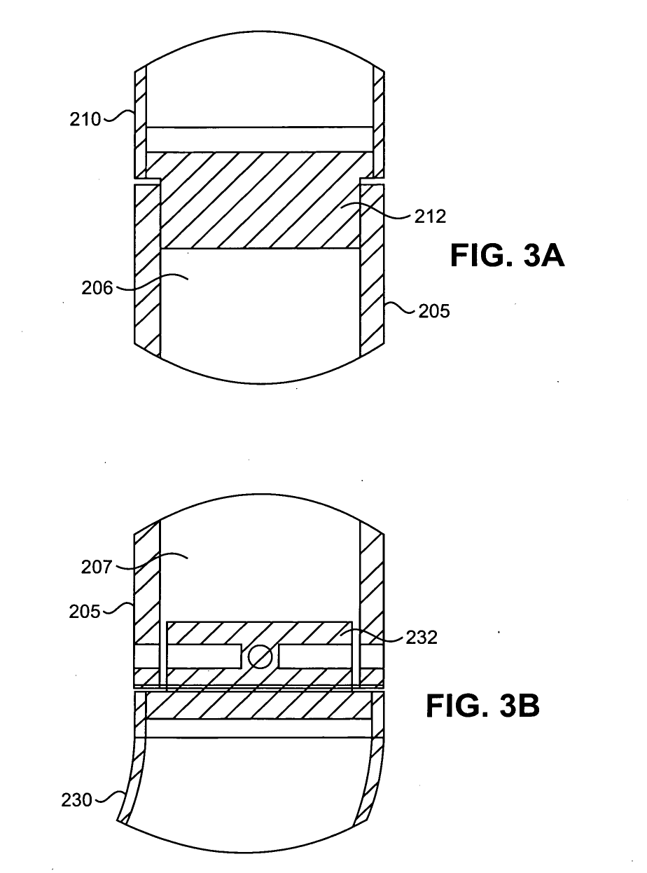

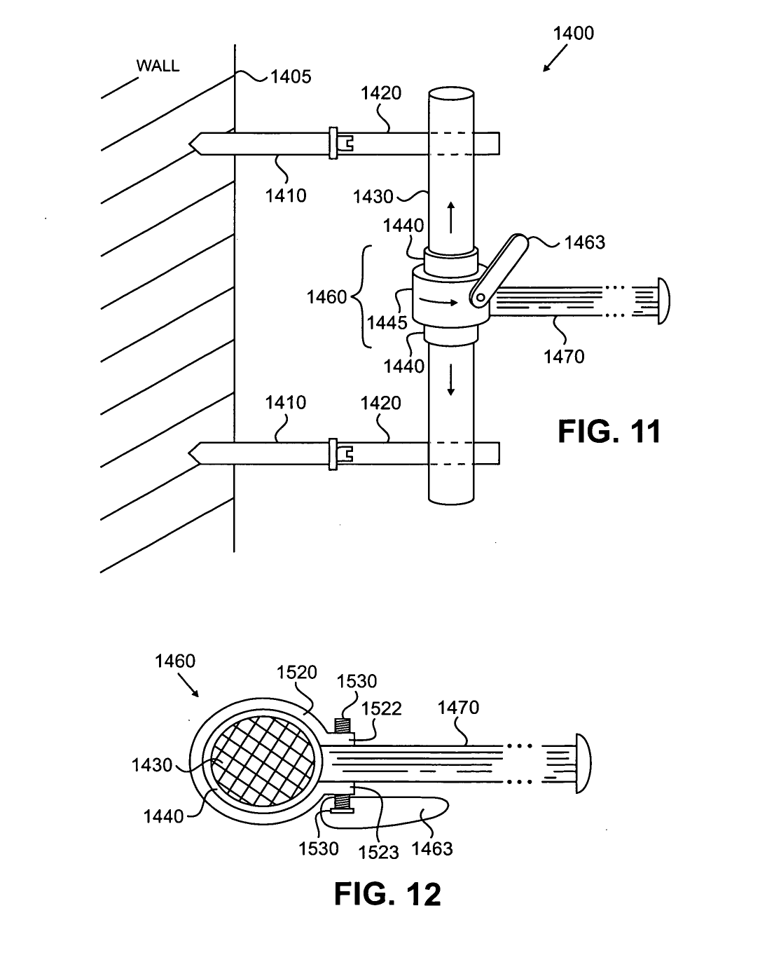

FIGS. 3A-3B are cross-sectional views of the open ends 206, 207 of the vertical bar 205, respectively, and the corresponding portions of the elbows 210, 230, respectively, showing the placement of the first and second plugs 212, 232. The first plug 212 is inserted between the top elbow 210 and a top end of the vertical bar 205 and is welded into the top elbow 210 and into the vertical bar 205, for example, by tigwelding, for example, as shown in FIG. 3A. One end of the second plug 232 is tigwelded into the bottom elbow 230; the other end is inserted into a bottom end of the vertical bar 205, to which it is attached by four set screws, for example, as shown in FIG. 3B. Instead of providing the elbows 210, 230, the vertical bar 205 could be connected to a wall 65 by other means, such as those discussed below with respect to FIG. 11.

### Vertical Ring Element

The vertical ring element 300 comprises a cylindrical collar configured to fit around the vertical bar 205 and move vertically up and down along the vertical bar 205. The vertical ring element 300 provides a mechanism to adjust the vertical position of the safety bar 600 vis-a-vis the vertical bar 205.

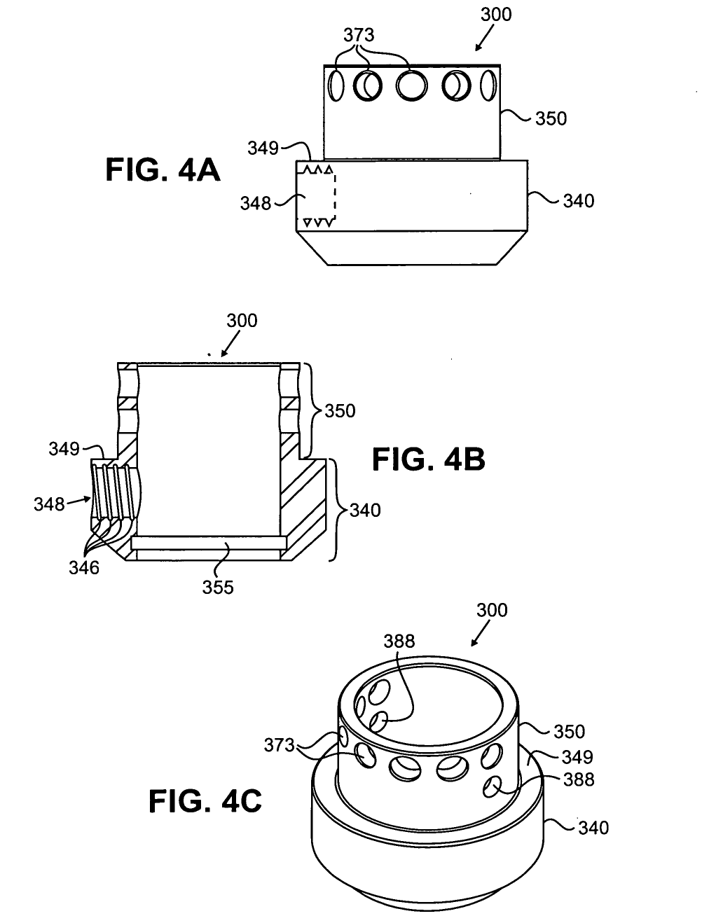

FIGS. 4A-4C show an exemplary structure of the vertical ring element 300, in accordance with the example of FIGS. 1A-1B. FIG. 4A is a side view of the vertical ring element 300. In FIG. 4A, a hole 348 of the vertical ring element 300 is shown in phantom. FIG. 4B is a cross-sectional view of the vertical ring element of FIG. 4A. FIG. 4C is a perspective view of the vertical ring element 300 of FIG. 3A.

Referring to FIG. 4A, the vertical ring element 300 comprises a cylindrical collar having a wider, lower portion 340 and a narrower, upper portion 350. An upper surface 349 of the lower portion 340 is perpendicular to the upper portion 350, in this example. The lower portion 340 comprises a hole 348, shown in phantom in FIG. 4A and in the cross-section of FIG. 4B, capable of being aligned with one of the holes 260 of the vertical bar 205.

The hole 348 is also configured to accept a spring-loaded pin 375, shown in FIG. 2. When the hole 348 is aligned with one of the holes 260 of the vertical bar 205, the spring-loaded pin 375 is insertable into the aligned holes, locking the vertical ring element 300 into place vis-a-vis the vertical bar 205. The hole 348 defines grooves 346 for tighter coupling between the lower portion 340 of the vertical ring element 300 and the spring-loaded pin 375, as discussed further below.

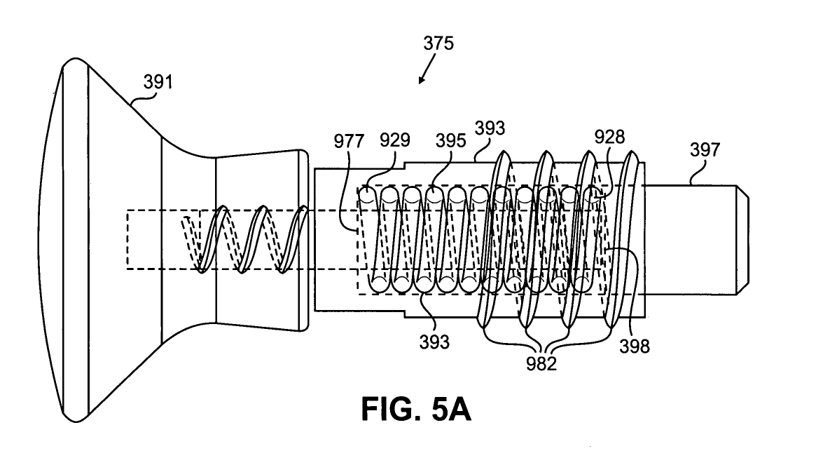

FIGS. 5A-5B show an exemplary structure of the spring-loaded pin 375, in accordance with the example of FIGS. 1A-1B. FIG. 5A is a side view of the pin 375 showing a knob 391, a pin portion 397, and certain components in phantom. FIG. 5B shows a rod 397-A and an end portion 397-B of the pin portion 397. A spring 395 fits around a portion of the rod 397-A. The spring 395 may have a spring constant of 15.0 pounds per inch, for example. A suitable spring may be obtained from the Lee Spring Company, located in Bristol, Conn., may be used.

A hollow, cylindrical capsule 393 fits around and over both the spring 395 and part of the rod 397-A, as shown in FIG. 5A. A first end 929 of the spring 395 is adjacent to an interior wall 977 of the capsule 393. A second end 928 of the spring 395 is adjacent to a surface 398 of the end portion 397-B. The rod 397-A comprises grooves 936 at one end, to couple the pin portion 397 to the knob 391. The capsule 393 comprises threads 982 configured to be coupled to the grooves 346 in the hole 348 (shown in FIG. 4B) of the vertical ring element 300.

When the capsule 393 is secured within the hole 348 of the vertical ring element 300, the knob 391 can be used to lock the end portion 397-B of the spring-loaded pin 375 into a selected hole 260 of the vertical bar 205, and to remove the end-portion 397-B from one of the holes 260.

Returning now to FIGS. 4A-4C, the narrower, upper portion 350 of the vertical ring element 300 comprises a plurality of circumferentially distributed holes 373. FIG. 4C shows the holes 373 extending partially around the upper portion 350. The position of each of the holes 373 defines a corresponding angular position that may be selected for the tube 400, the handle 500 and the safety bar 600 with respect to the vertical bar 205 and wall 65. The bottom of the tube 400 may rest on the ledge 349. The tube 400, the handle 500 and the safety bar 600 are thereby supported by the vertical ring element 300 at a selected height and angle, as discussed in more detail below.

A user can move the vertical ring element 300 (and the tube 400 and the safety bar 600) from a first vertical position corresponding to the selected hole 260 to a second vertical position. Assuming, for example, that the end portion 397-B is presently secured within a selected one of the holes 260 of the vertical bar 205, the user disengages the end portion 397-A from the hole 260 by pulling on the knob 391 (to the left in FIG. 4C) with one hand. Pulling on the knob 391 moves the rod 397-A and the end portion 397-B radially outward with respect to the capsule 393 to withdraw the end portion 397-B from the selected hole 260 of the vertical bar 205. Pulling the knob 391 also causes the spring 395 to be compressed.

The user then can use the other hand to move the vertical ring element 300 up or down to a second vertical position corresponding to a second selected one of the holes 260 in the vertical bar 205, which also moves the tube 400 and the safety bar 600 which is coupled to the tube 400. With one hand holding the knob 391 in its disengaged position, the user may exert upward or downward force on the vertical ring element 300, if desired, by grabbing the vertical ring element 300 and/or the tube 400 collar 500, and safety bar 600, if desired or needed, with the user's free hand, and pushing up or down to move the vertical ring element to a desired vertical height. After the vertical ring element 300 is moved to a second selected position, and the hole 348 thereof is aligned with a second selected one of the holes 260 in the vertical bar 205, then the knob 391 is released or moved toward the vertical bar 205. The user can feel that the end portion 397-B of the spring loaded pin 375B aligned with a hole 260 by a slight movement of the end portion into the hole under the force of the spring, for example. Releasing the knob 391 causes the spring 395 to push the end portion 397-B into the second selected hole 260 of the vertical bar 205.

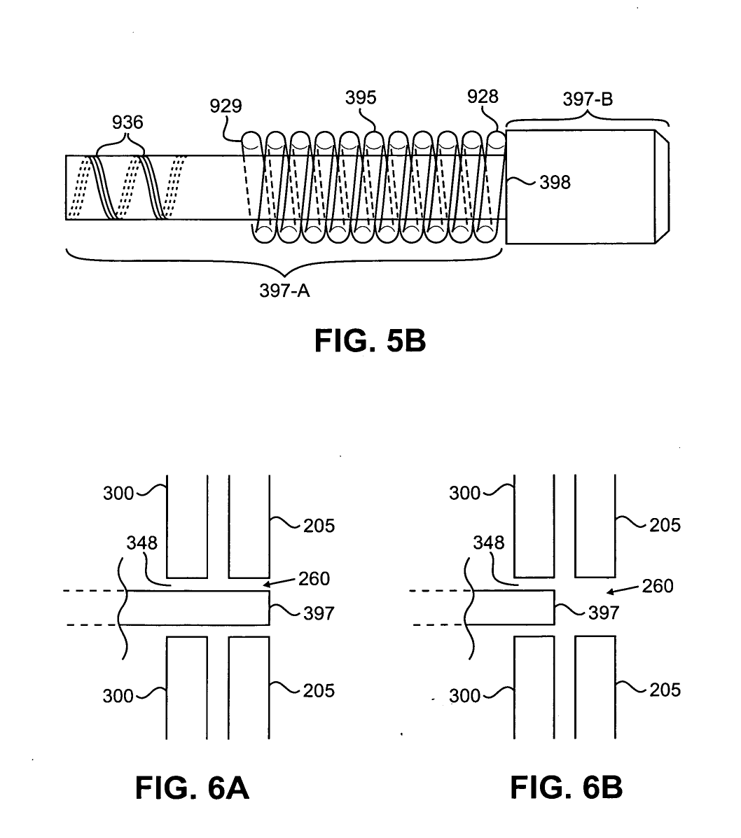

Accordingly, the pin portion 397 of the spring-loaded pin 375 has two positions, as shown in the schematic representation of FIGS. 6A-6B. In a first position, shown in FIG. 6A, the hole 348 of the vertical ring element 300 is aligned with one of the holes 260 of the vertical bar 205 and the pin portion 397 is aligned with and secured within the hole 260 of the vertical bar 205. When the spring-loaded pin 375 is in its first, secured position, the vertical ring element 300 is secured in place, both vertically and rotationally, vis-a-vis the vertical bar 205, and the spring 395 is relaxed (uncompressed).

In its second, unsecured, position, shown in FIG. 6B, the pin portion 397 of the spring-loaded pin 375 is removed from any of the holes 260 in the vertical bar 205. In its unsecured position, the pin portion 397 is withdrawn at least partially through the capsule 393, while the capsule 393 remains engaged within the hole 348 of the vertical ring element 300. In this position, the pin portion 397 is within a region defined by the hole 348, as well, but that is not required. When the pin portion 397 is in this second, unsecured, position, the spring 395 is compressed, providing a return force on the pin portion 397 to return the pin portion to the first position. Other resilient elements, such as a piece of rubber, for example, may be provided instead of the spring 395.

### Tube, Collar and Safety Bar

Returning to FIG. 2, the tube 400 and the safety bar 600 are coupled together to enable a user to adjust the horizontal, or angular, position of the safety bar 600 with respect to the wall 65. In this example, the safety bar 600 is connected to the tube 400. The tube 400 comprises a hollow cylindrical member coupled to the safety bar 600. The tube 400 is configured to fit around the vertical bar 205, and provides a mechanism for rotating the safety bar 600 around the vertical bar 205. The tube 400 is also configured to fit around and over the upper portion 350 of the vertical ring element 300. The safety bar 600 provides a stable bar which a user can grip while entering or exiting, or while moving within, a bathtub.

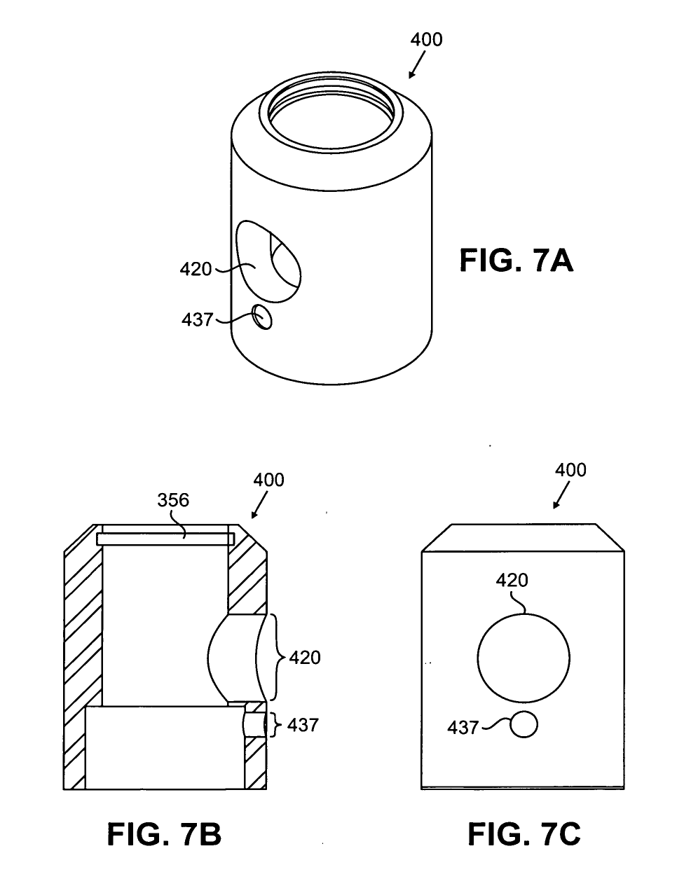

FIGS. 7A-7C show an exemplary structure of the tube 400, in accordance with the example of FIGS. 1A-1B. FIG. 7A is a perspective view of the tube 400 showing FIG. 7B is a cross-sectional view of the tube 400 through the opening 420. FIG. 7C is a front view of the tube 400 showing the opening 420. FIGS. 7A-7C also show a smaller opening 437 for receiving a pin 521 showing an opening 420 configured to accept an end of the safety bar 600.

Returning to FIG. 2, the pin 521 is coupled to a member that is movable with respect to the safety bar 600. In this example, the member is a tubular member, such as a collar 500 that surrounds a portion of the safety bar 600. The pin 525 is engaged in the corresponding one of the holes 373 of the vertical ring element 300, to secure the bar into a particular angular position. To adjust the horizontal position of the safety bar 600 to a different angular position, the user pulls the collar 500 radially outward with respect to the vertical bar 205 until the pin 521 becomes disengaged from the currently selected hole 373. A resilient element, such as a spring 710, bears against the collar when the collar is pulled. The user rotates the safety bar 600 around the vertical bar 205 to a second angular position corresponding to a selected second one of the holes 373 in the vertical ring element 300 while the pin 521 is disengaged from the holes 373. When aligned with the selected second hole 373 at the desired second angular position, the user releases the collar 500, or moves the collar toward the tube 400 so that the pin 521 is moved into the desired hole.

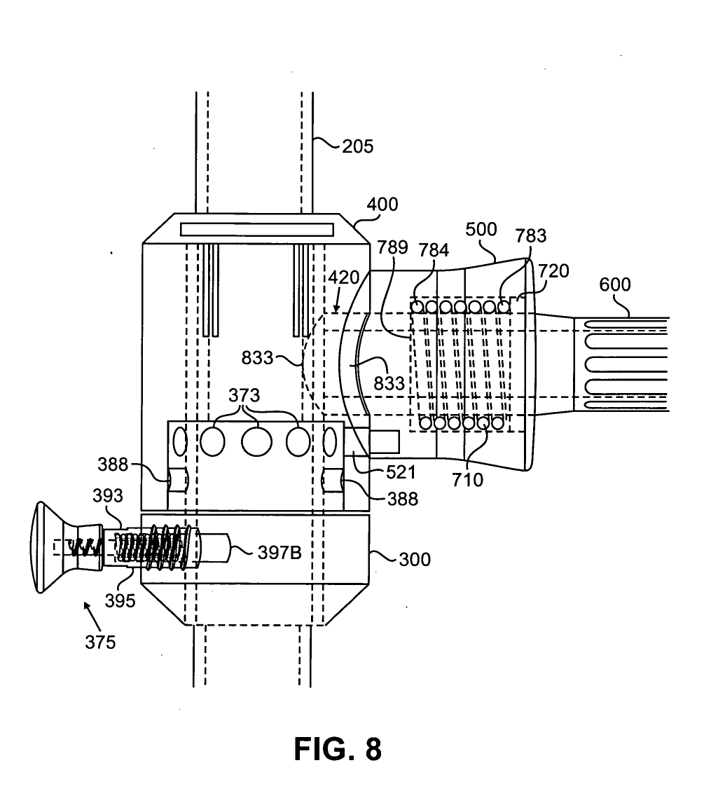

FIG. 8 shows an exemplary structure of the collar 500, the tube 400 and the safety bar 600, in further detail, with internal components shown in phantom, in accordance with the example of FIGS. 1A-1B. The collar 500 in this example comprises a tubular member that is approximately cylindrical in shape, with a hollow interior configured to fit around and over a portion of the safety bar 600. (See also FIG. 2.) A first end portion 833 of the safety bar 600 is welded to the opening 420 of the tube 400 (also shown in FIGS. 7A-7C), by tigwelding, for example. When welded to the tube 400, the end 833 of the safety bar 600 is flush with the inner diameter of the tube 400.

In one example, the collar 500 is formed to have a shape that may be easily gripped and handled by a person using the safety bar system 50 in a bathtub, as shown in FIGS. 1A, 1B, 2, and 8, for example. The pin 521 is coupled to the collar 500 and is configured to fit into one of the holes 373 of the upper portion 350 of the vertical ring element 300. (See FIGS. 2 and 8.)

A spring 710 and a push fit ring 720 are coupled to the safety bar 600 and are covered by the collar 500. (See FIGS. 2 and 8.) The spring 710 fits around and over a portion of the safety bar 600. One end 783 of the spring 720 is supported and anchored by a push fit ring 720, which fits around the safety bar 600. Another end 784 of the spring bears against an interior surface 789 of the collar 500. The spring 720 has a spring constant of 7.22 pounds per inch, for example. A suitable spring may be obtained from the Lee Spring Company, located in Bristol, Conn., may be used.

The collar 500 has two positions. In a first position, the collar 500 is in contact with the tube 400, and the pin 521 is engaged through the hole 437 of the tube 400, and engaged in a selected hole 373 of the vertical ring element 300. In the first position, the collar 500 and the safety bar 600 are locked in an angular position defined by the selected hole 373 of the vertical ring element 300. When the collar 500 is in its first position, the spring 710 is relaxed (uncompressed). In a second position, the collar 500 is pulled away from the tube 400, and the pin 521 is disengaged from any of the holes 373 of the vertical ring element 300. When the collar 500 is in its second position, the spring 710 is compressed.

A user may use the collar 500 to move the safety bar 600 from a first angular position to a second angular position by gripping the collar 500 and pulling the collar 500 away from the tube 400 in order to disengage the pin 521 from the first hole 373. When the collar 500 is pulled away from the tube 400, the spring 710 is compressed. While in this second, disengaged position, the pin 521 may remain engaged in the hole 437 of the tube 400 but is not engaged in any of the holes 373 of the vertical ring element 300, in a similar manner as the pin 397 is moved out of the hole 260 in FIG. 6B. While the collar 500 is in its second, disengaged, position where the pin 521 is disengaged from the holes 373 of the vertical ring element 300, the user manually rotates the tube 400 about the vertical bar 205 by turning the safety bar 600 to a second desired angular position, where the pin 521 is aligned with a selected second one of the holes 373 of the vertical ring element 300. The user then releases or moves the collar 500 toward the vertical bar 205, moving the pin 521 into the selected second hole 373 of the vertical ring element 300. The collar 500 and the safety bar 600 thereby become locked into the second hole 373, and secured in a second angular position vis-a-vis the vertical bar 205.

The safety bar 600 comprises a rod configured to be gripped by a user. The safety bar 600 may comprise any suitable material, such as stainless steel, for example. A portion of the safety bar 600 may include grooves on the surface to facilitate a user's grip, as shown. In the example of FIGS. 1A, 1B and 2, a plug 755 is inserted at a second end 992 of the safety bar 600.

### Sleeve

Returning to FIG. 2, a cylindrical sleeve 660 may be provided between the tube 400 and the vertical ring element 300, and the vertical bar 205, to facilitate the movement of these components up and down, and around, the vertical bar 205. The sleeve 660 in this example comprises a low-friction material, such as nylon. In another example, the sleeve comprises polypropylene. The sleeve 660 may also comprise rubber, polypropylene or polytetrafluoroethylene (“PTFE”), also known as Teflon. The inner sleeve 660 may alternatively comprise an acetal resin engineering plastic, such as Delrin® plastic. Delrin® plastic is available from E.I. Du Pont de Nemours and Company, located in Wilmington, Del.

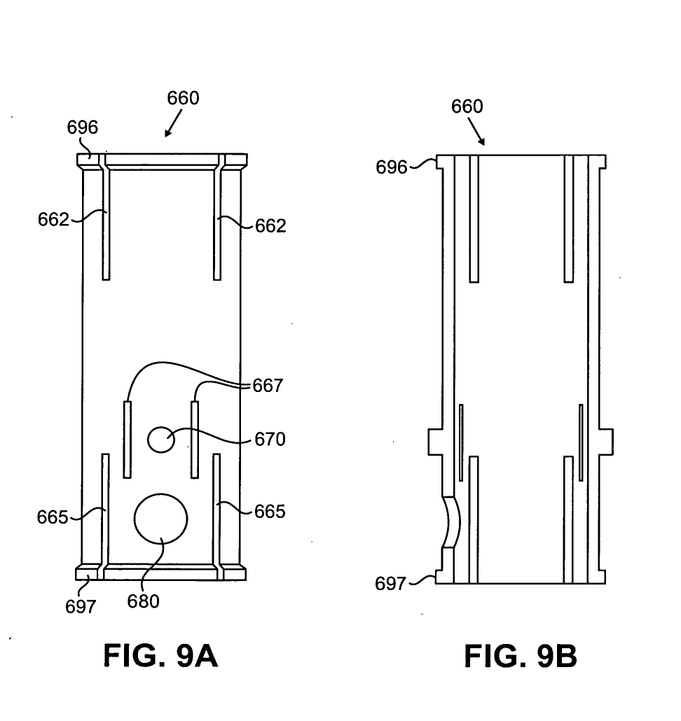

FIGS. 9A-9B show an example of the sleeve 660, in accordance with an embodiment of the invention. FIG. 9A is a front view of the sleeve 660. FIG. 9B is a cross-sectional view of the sleeve 660. The sleeve 660 comprises one or more upper slits 662 and lower slits 665 that facilitate the sleeve 660 being fit around the vertical bar 205. The sleeve 660 also comprises one or more central slits 667 that further facilitate the sleeve 660 being fit in place. The sleeve 660 also comprises a hole 680, which is aligned with the hole 348 of the vertical ring element 300 (shown in FIG. 4C).

The sleeve 660 additionally comprises one or more protrusions 670 configured to fit into the holes 388 in the vertical ring element 300, to secure the sleeve 660 in place vis-a-vis the vertical ring element 300. In addition, upper and lower expanded edges 696, 697 are provided at the top and bottom of the sleeve 400. The bottom edge 697 fits within an internal groove 355 in the vertical ring 300. (See FIG. 4B). The upper edge 696 fits within an internal groove 356 of the tube 400, shown in FIG. 7B. Returning to FIG. 4B, the vertical ring element 300 comprises one or more holes 388 configured to accept the one or more protrusions 670.

### Another Example

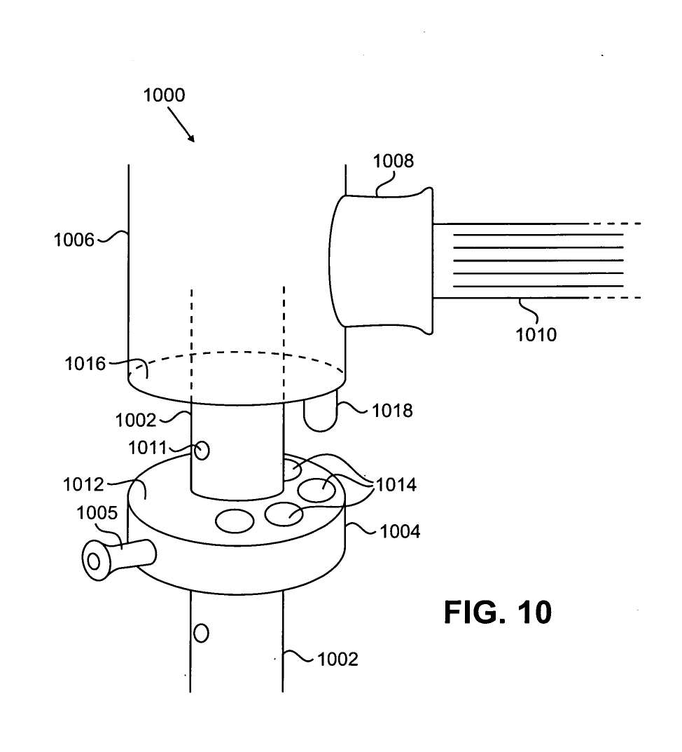

FIG. 10 is another example of a safety bar system 1000, in accordance with the embodiment of FIGS. 1-9. The safety bar system 1000 comprises a vertical bar 1002, a vertical ring element 1004, a spring loaded pin 1005, a tube 1006, an optional collar 1008, and a safety bar 1010. In this example, the structure and function of the vertical bar 1010 is the same as the vertical bar 205, which is shown in FIGS. 1A, 1B, and 2, and described above, including having a vertical row of holes 1011, one of which is shown in FIG. 10. The vertical ring element 1004 and spring loaded pin 1005 is also the same, as described above, except that the upper portion 350 is not needed. Instead, the top surface 1012 of the vertical ring element 1004 includes a plurality of circumferentially distributed holes 1014. Each of the holes 1014 defines a corresponding angular position which may be selected for the safety bar 1010, as discussed below.

The tube 1006 comprises a hollow cylindrical member also configured to fit around, and to move up and down along, the vertical bar 1002, as described above with respect to the tube 400. The tube 1006 comprises a lower surface 1016 (shown in phantom in FIG. 10). The safety bar 1010 is coupled to a hole (not shown) through a wall of the tube 1006, as described above with respect to the hole 420 in the tube 400. A pin 1018 is coupled to the lower surface 1016, facing the vertical ring 1004. The pin 1018 is configured to fit into a selected one of the holes 1014 on the top surface 1012 of the vertical ring element 1004.

In the example of FIG. 10, when the pin 1018 is engaged within one of the holes 1014, the tube 1006 and the safety bar 1010 are secured in a corresponding angular and vertical position. The vertical height of the bar is adjusted via the vertical ring 1004 and spring loaded pin 1015, as described above. The angular position of the tube 1006 and safety bar 1010 may be adjusted by grabbing the tube by one hand and lifting the tube (and safety bar) until the pin 1018 becomes disengaged from the hole 1014. The user can then rotate the tube 1006 (and the safety bar 1010) to a second angular position corresponding to a second selected one of the holes 1014. When the pin 1018 is aligned with the second selected hole 1014, the tube 1006 is lowered until the pin enters into and becomes engaged in the second selected hole 1014. The optional collar 1008, or the safety bar 1010 at a location close to the tube 1006, may be grasped, instead.

### Alternative Embodiments

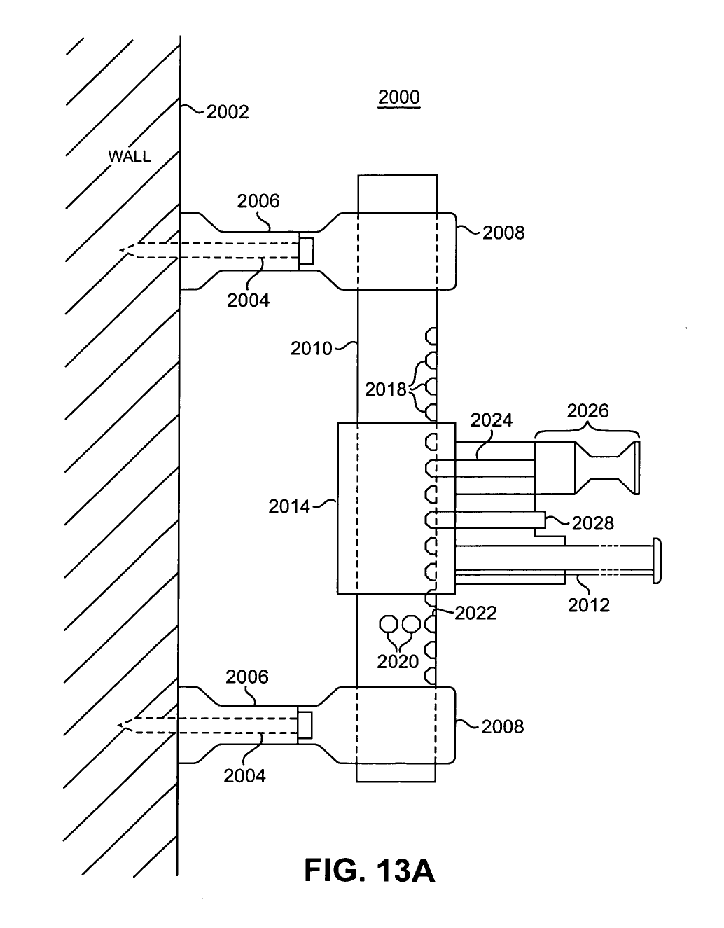

FIG. 11 is an example of a bathtub support system 1400, in accordance with another embodiment of the invention. Here, the bathtub support system 1400 comprises a wall 1405 adjacent a bathtub (not shown), for example, two dowels 1410 connected to the wall, two extending members 1420 (or anchor rods) attached to the dowels 1410, and a vertical bar 1430 (or slide rod) supported by the extending members 1420. The vertical bar 1430 may be configured as described above with respect to FIGS. 1A-3B, instead. A safety bar 1470 is coupled to the vertical bar 1430 by a coupling mechanism 1460 allowing vertical movement along the vertical bar and rotational movement around the vertical bar. The coupling mechanism 1460 comprises an inner sleeve 1440 coupled around the connecting member 1430 and an outer tubular member 1445. The outer tubular member 1445 is open along one side, as shown in the top view of FIG. 12. The safety bar 1470 is connected to the tubular member 1445 for movement with the tubular member and inner sleeve 1440. The inner sleeve 1440 may comprise nylon or the other low friction materials described above with respect to the sleeve 660. The tubular member 1445 and the inner sleeve 1440 are movable vertically along the vertical bar 1430 and rotationally around the vertical bar.

In this example, the dowels 1410 are placed in the wall 1405 one above the other such that the connecting member 1430 is positioned vertically and parallel to the wall 1405. The dowels 1410 may be placed in the wall 1405 at the location of a wall stud, for example, or in other positions.

The inner sleeve 1440 may be mechanically coupled to the tubular member 1445 by techniques known in the art. For example, one or more shoulders or protrusions of the inner sleeve 1440 may be attached to or fitted into one or more grooves or indents in the tubular member 1445, as is also shown above with respect to the sleeve 660, vertical ring element 300, and tube 400.

A locking mechanism 1460 is provided to selectively compress the tubular member 1445 around the inner sleeve 1440 to tighten and secure the tubular member 1445, and thereby the safety bar 1470, to the vertical bar 1430 in a desired vertical and rotational position. In this example, a screw 1530 connects open ends 1522, 1523 of the tubular member 1445, through the safety bar 1470, as shown in FIG. 12. The resulting configuration is similar to a C-clamp. Turning the screw 1530 in a first direction causes the tubular member 1445 to tighten around the vertical bar 1430, securing the safety bar 1470 at a desired height and angle. Turning the screw in a second direction opposite the first direction causes the tubular member 1445 to loosen, enabling the safety bar 1470 to be moved vertically along the vertical bar 1430 to a desired vertical position, and rotated about the vertical bar to a desired angular position, by a user grasping the tubular member 1445 and/or the safety bar 1470, proximate the tubular member. A handle 1463 may be coupled to the screw 1530 to facilitate rotation of the screw 1530 during use. The handle 1463 shown in FIGS. 10 and 11 is merely exemplary. The handle 1463 may have other shapes and sizes. The handle 1463 may be longer, for example.

In the example of FIG. 12, the handle 1463 and the screw 1530 are shown as separate pieces coupled together. Alternatively, the handle 1463 and the screw 1530 may be integrated into a single piece.

The vertical bar 1430, the locking mechanism 1460, and the safety bar 1470 may comprise any suitable material, such as a metal or metal alloy, plastic, wood, one or more composite materials, etc., or a combination of such materials.

In another example, the locking mechanism 1460 may comprise a snap-clip, such a mechanism commonly used to tighten ski boots (not shown). A first portion of the clip may be positioned near a first open end of the tubular member 1445 and a second portion positioned near the second open end of the tubular member. When the first portion is snapped onto the second portion, closing the snap-clip, the tubular member 1445 is compressed against and becomes fixed securely to the vertical bar 1430. When the snap-clip is open, the locking mechanism 1460 (and the safety bar 1470) can be moved vertically along the vertical bar 1430 to a desired vertical position, and rotated horizontally about the vertical bar 1430 to a desired rotational position, as described above.

As discussed above, the safety bar system 1400 may be attached to a wall 1405 adjacent to a bathtub, for example. A person wishing to enter the bathtub, or to sit down in the bathtub, may use the safety bar system 1400 in the following manner. If the angular position of the safety bar 1470 is initially against the wall (for storage, for example), the person may first determine whether the safety bar 1470 is presently situated at a desired vertical position, or height. If the person determines that the height needs to be adjusted, the person may, while standing either outside or inside the bathtub, loosen the locking mechanism 1460 by turning the handle 1463 in a first direction and move the safety bar 1460 up or down along the connecting member 1430 to a desired vertical position. The person may also rotate the safety bar 1470 around the connecting member 1430 to a desired rotational position. The person then tightens the locking mechanism 1460 by turning the handle 1463 in a second direction opposite the first direction. The person may then grip the safety bar 1470 firmly while entering and/or sitting down in the bathtub. The person may subsequently loosen the locking mechanism 1460 by rotating the handle 1463 in the first direction and rotate the safety bar 1470 against the wall, for example, and tighten it again, while in the bathtub, so that the bar 1470 does not interfere with the person's movements in the bathtub, if desired. The person may use the safety bar system 1400 in a similar manner when standing up in and/or exiting the bathtub.

In the example of FIG. 11, the safety bar 1470 is configured to move continuously in both the horizontal and vertical planes. A person using the safety bar system 1400 may therefore move the bar 1470 smoothly to any desired horizontal and vertical position, and lock the bar 1470 into the selected position. This provides flexibility for use by different people, such as different family members, of different sizes and strength, for example.

It is noted that the compression type system described with respect to the embodiment of FIGS. 11 and 12 may be used in conjunction with the first embodiment to secure the tubular member 400 to the upper wall 350 of the vertical ring element 300, and allow for rotation of the tubular member 400 around the upper portion 350. In that case, the vertical height would be adjusted by movement of the vertical ring element 300, as discussed above.

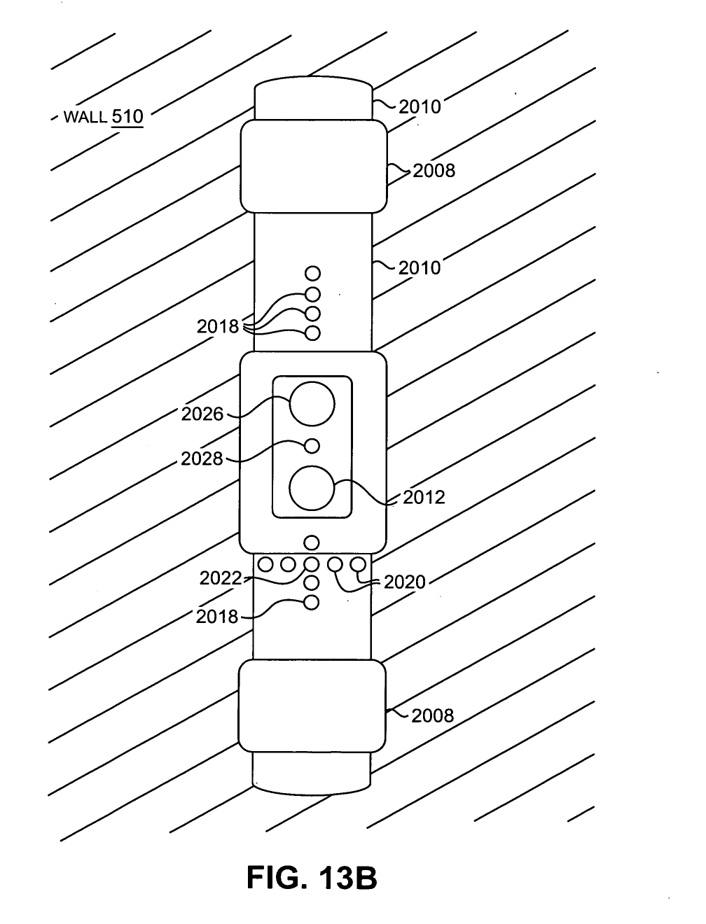

FIGS. 13A-13B show side and front views, respectively, of an example of a safety bar system 2000, in accordance with another embodiment of the invention. The safety bar system 2000 comprises a wall 2002, two dowels 2004 connected to the wall 2002, two extending members 2006 attached to the dowels 2004, two supporting members 2008 connected to the extending members 2006, and a vertical bar 2010 supported by the supporting members 2008. In this example, the two dowels 2004 are secured to the wall 2002 one above the other such that the vertical bar 2010 is positioned vertically. Each supporting member 2008 and the attached extending member 2006 may be integrated into a single element. In this case, the connecting member 2010 is supported by the integrated element.

A safety bar 2012 is coupled to the vertical bar 2010 by a coupling mechanism comprising a tube 2014, which allows vertical movement along the vertical bar and rotational movement around the vertical bar. A plurality of holes or grooves are defined through a surface of the vertical bar 2010. In this example, the vertical bar 2010 comprises a series of fourteen holes 2018 positioned vertically, and a series of five holes 2020, only three of which are visible in FIG. 13, transverse to the vertical holes, in a horizontal row, for example. The vertical series of holes 2018 and the horizontal series of holes 2020 intersect at (and include) a hole 2022. Additional horizontal and/or vertical holes 2018, 2020 may be provided along the same rows or in additional rows, parallel to the rows shown in FIG. 13A, 13B, for example. The holes 2018, 2020 may be ¾ inch apart, for example.

The tube 2014 also holds a locking bolt or pin 2024 coupled to a hand grip 2026. The locking bolt 2024 may be spring activated, for example. When the locking bolt 2024 is secured within one of the holes 2018, 2020, the safety bar 2012 is situated at a corresponding height and angle with respect to the vertical bar 2010. A user may employ the hand grip 2026 to pull the locking bolt 2024 out of one of the holes 2018, 2020, and may then adjust the vertical position of the safety bar 2012 with respect to the vertical bar 2010 to a selected height associated with another one of the holes 2018, and release the locking bolt into the other hole. To change the angle of the safety bar 2012, the locking bolt 2024 removed from a hole, aligned with the horizontal row of holes 2020, rotated, along with the tube 2014, into alignment with the hole in the desired position, and then released into the other hole. The locking bolt 2024 may be a part number 03097-02206 from Kipp, Inc., Stevensville, Mich., or Kipp, Inc., Germany, for example, or may be configured in a similar manner to the spring loaded pins described above.

A spring loaded pin 2028 may also be provided through the tube 2014, for added stability. When the locking bolt 2024 engages one hole 575, the spring loaded pin 573 may engage an adjacent or other hole 575. Movement of the collar 550 up or down moves the spring loaded pin 575 out of the one hole 575 and into the next hole when the pin 575 is aligned with the next hole. Spring loaded pins may also be obtained from Kipp, Inc.

In another example, the horizontal row of holes is not provided and the safety bar 2012 may only be moved vertically.

In other examples, the systems described herein may be attached to a bar or frame that is placed in our near a bathtub. In one example, the safety bar system may be supported structurally by the floor, the bathtub, and/or the ceiling. Therefore, in this example, the apparatus need not be attached to a wall.

The systems described herein may also be installed and used in a sauna, in a Jacuzzi, in a swimming pool or other type of pool. In other examples, the systems described herein may also be installed and used near a toilet to assist an individual to use the toilet.

The foregoing merely illustrates the principles of the invention. It will thus be appreciated that those skilled in the art will be able to devise numerous other arrangements which embody the principles of the invention and are thus within its spirit and scope, as defined by the claims below.

I claim:

1. A safety bar system comprising:
a first bar having a length and defining a plurality of first holes along the length, the first bar configured to be coupled to a wall;
a first tubular member around the first bar, the first tubular member being movable with respect to the first bar, and selectively lockable to one of the plurality of holes;
a second tubular member rotatable around the first member, the second tubular member being selectively lockable to the first member in a selected one of a plurality of positions around the first tubular member; and
a second bar coupled to the second tubular member such that selective locking of the first tubular member to one of the plurality of holes and selective locking of the second tubular member to the first member defines a position of the second bar with respect to the first bar.

2. The system of claim 1, wherein:
the first tubular member defines a second hole therethrough, the second hole being selectively alignable with a selected one of the plurality of first holes; and
the system further comprising an elongated member insertable into an aligned first and second hole, to selectively lock the first tubular member to the selected first hole.

3. The system of claim 2, further comprising:
a resilient member coupled to the elongated member;
wherein:
the elongated member has a first position within an aligned first and second hole; and
the elongated member has a second position outside of each of the plurality of first holes, to allow for movement of the first tubular member with respect to the first bar;
wherein the resilient member provides a force pushing the elongated member into the first position and resists movement of the elongated member into the second position.

4. The system of claim 3, wherein:
the resilient member comprises a spring; and
the elongated member is removable from the hole by manually retracting the member from the first hole, compressing the spring.

5. The system of claim 3, wherein:
the first tubular member defines a circumferential section at least partially around the bar and a plurality of third holes circumferentially distributed around the circumferential section, radially through the circumferential section; and
the second tubular member defines a fourth hole alignable with a selected one of the third holes; and
the system further comprises a second elongated member insertable into an aligned third and fourth hole, to lock the second tubular member and the second bar into a selected angular position.

6. The system of claim 5, further comprising:
a second resilient member coupled to the second elongated member;
wherein:
the second elongated member has a first position within an aligned third and fourth holes; and
the second elongated member has a second position outside of each of the plurality of third holes, to allow for movement of the second tubular member around the first tubular member to align the fourth hole with another third hole; and
the resilient member provides a force pushing the second elongated member into the first position and resists movement of the second elongated member into the second position.

7. The system of claim 6, wherein:
the resilient member comprises a spring; and
the second elongated member is removable from the third hole by manually retracting the second member from the third hole, compressing the spring.

8. The system of claim 6, wherein the second elongated member is movably coupled to the second bar.

9. The system of claim 8, further comprising:
a third member movably coupled to the second bar and movable with respect thereto;
wherein the second elongated member is coupled to the third member; and
movement of the third member with respect to the second bar causes movement of the second elongated member between the first and second positions.

10. The system of claim 9, wherein:
the third member comprises a third tubular member surrounding the second bar.

11. The system of claim 1, wherein:
the first tubular member defines a circumferential section at least partially around the bar and a plurality of second holes circumferentially distributed around the circumferential section, radially through the circumferential section; and
the second tubular member defines a third hole alignable with a selected one of the second holes; and
the system further comprises a first elongated member insertable into an aligned second and third holes, to lock the second tubular member and the second bar into a selected angular position.

12. The system of claim 11 further comprising:
a first resilient member coupled to the first elongated member;
wherein:
the first elongated member has a first position within an aligned second and third holes; and
the first elongated member has a second position outside of each of the plurality of second holes, to allow for movement of the second tubular member around the first tubular member to align the second hole with another first hole; and
the resilient member provides a force pushing the first elongated member into the first position and resists movement of the first elongated member into the second position.

13. The system of claim 12, wherein:
the resilient member comprises a spring; and
the first elongated member is removable from a second hole by manually retracting the first elongated member from the second hole, compressing the spring.

14. The system of claim 12, wherein the second elongated member is movably coupled to the second bar.

15. The system of claim 14, further comprising:
a third member movably coupled to the second bar and movable with respect thereto;
wherein the first elongated member is coupled to the third member; and
movement of the third tubular member with respect to the second bar causes movement of the second elongated member between the first and second positions.

16. The system of claim 15, wherein:
the third member comprises a tubular member surrounding the second bar.

17. The safety bar system of claim 1, wherein the second tubular member and the second bar are selectively lockable in a continuous plurality of positions within a range of locations around the bar.

18. The system of claim 17, wherein:
the second tubular member comprises is compressible around a portion of the first tubular member, to selectively lock the second tubular member to the first tubular member.

19. The system of claim 11 wherein:
the second tubular member comprises a C-clamp.

20. The system of claim 1, wherein:
the first tubular member defines a ledge perpendicular to thereto, the ledge having a plurality of circumferential holes extending at least partially around the first tubular member, parallel to the first bar;
the second tubular member comprises an elongated member extending therefrom, toward the first tubular member and parallel to the first bar, the elongated member being receivable in a selected one of the plurality of circumferential holes; and
the angular position of the second bar is varied by lifting the second tubular member to remove the elongated member out of one circumferential hole, rotating the second tubular member around the bar, and lowering the second tubular member to move the elongated member into another circumferential hole.

21. The system of claim 1, wherein the first bar is coupled to a wall in a vertical position.

22. The system of claim 17, wherein the wall is adjacent to a bathtub and the second bar is extendible across the bathtub.

23. A method of using a safety bar, comprising:
moving a first member vertically along a bar to a selected height, to set the height of a horizontal bar;
locking the first member to the bar at the selected height;
rotating a second member separate from the first member around the bar to a selected position, the second member being coupled to a horizontal bar; and
locking the second member in the selected position.

24. The method of claim 23, further comprising:
grasping the horizontal bar; and
entering a bathtub.

25. The method of claim 23, further comprising:
grasping the horizontal bar; and
exiting the bathtub.

26. A safety bar system comprising:
a first bar;
a tubular member around the first bar; and
a second bar coupled to the tubular member;
wherein:
the tubular member is movable along a length of the first bar and around the first bar to position the tubular member and the second bar into one of a continuous plurality of positions with respect to the bar; and
the tubular member is selectively compressible to lock the tubular member into the selected one of the continuous plurality of positions with respect to the vertical bar.

27. The system of claim 26, wherein the tubular member comprises a C-clamp.

28. A safety bar system, comprising;
a first bar having a length and defining a plurality of first holes along the length, the bar configured to be coupled to a wall.
a tubular member around the first bar, the tubular member being movable with respect to the first bar and selectively lockable to one of the plurality of holes; and
a second bar coupled to the tubular member, such that selective locking of the tubular member to one of the plurality of holes defines a position of the second bar with respect to the first bar.

29. The system of claim 28, wherein:
the vertical bar defines a plurality of second holes transverse to the first holes; and
the first bar is selectively lockable to one of the second holes.

30. The system of claim 29, wherein the first holes are in a vertical line and the second holes are a horizontal line intersecting the first, vertical line.
